(19) United States
(12) Patent Application Publication
(10) Pub. No.: US 2023/0410568 A1
(43) Pub. Date: Dec. 21, 2023

(54) DETERMINATION SYSTEM, SERVER, DETERMINATION METHOD, AND NON-TRANSITORY COMPUTER READABLE MEDIUM

(71) Applicant: NEC Corporation, Minato-ku, Tokyo (JP)

(72) Inventor: Masahiro Yamanouchi, Tokyo (JP)

(73) Assignee: NEC Corporation, Minato-ku, Tokyo (JP)

(21) Appl. No.: 18/037,948

(22) PCT Filed: Nov. 25, 2020
(86) PCT No.: PCT/JP2020/043741

§ 371 Date: May 19, 2023

(51) Int. Cl. G07C 5/08; G07C 5/00

(52) U.S. Cl. CPC G07C 5/0808; G07C 5/008; G07C 5/0816

(57) ABSTRACT

An object is to provide a determination system, a server, a determination method, and a non-transitory computer readable medium that allow appropriate determination of a defective part of a vehicle. A determination system (1) according to the present disclosure includes: a server (40); a travel data transmission apparatus (10) configured to acquire travel data indicating a state of a vehicle during traveling and transmit the travel data to the server (40); and a parking data transmission apparatus (11) configured to acquire parking data indicating a state of the vehicle during parking and transmits the parking data to the server (40). The server (40) includes: a reception unit (41) configured to receive the travel data and parking data; and a determination unit (42) configured to determine a defective part of the vehicle on the basis of the received travel data and the received parking data.

### TECHNICAL FIELD

The present disclosure relates to a determination system, a server, a determination method, and a non-transitory computer readable medium.

### BACKGROUND ART

Users of automobiles are obliged to perform inspection and maintenance so that the automobiles conform to safety standards. Inspection and maintenance prescribed by laws and regulations include daily and regular inspections. In particular, daily inspection and maintenance are required to be performed once a day on business vehicles. In addition, the implementation cycle of the periodic inspection and maintenance for business vehicles is set shorter than that for private vehicles.

As a related art, for example, Patent Literature 1 discloses a vehicle travel data recording and analysis apparatus. The vehicle travel data recording and analysis apparatus described in Patent Literature 1 includes a measurement apparatus and a data analysis apparatus. The measurement apparatus is installed in a vehicle and measures the traveling state of the vehicle. The measurement apparatus measures a subject vehicle position on the basis of positioning information received from the outside, and calculates a traveling trajectory of the subject vehicle on the basis of data of the subject vehicle position. The measurement apparatus also calculates travel data on the basis of the measurement signal output from a traveling state detection unit that detects the traveling state of the subject vehicle. The data analysis apparatus reads the data of the traveling trajectory and the travel data and displays the data on the display unit.

As another related art, Patent Literature 2 discloses a wide-area vehicle state management system. In the wide-area vehicle state management system described in Patent Literature 2, the collection means collects data from a sensor or the like. The data includes measurement result data of a physical displacement amount with respect to the reference value of a vehicle component detected by a vehicle state sensor provided in the vehicle, time data at the time of measurement, and vehicle identification data. The reference data holding means holds reference data of a normal operation range of the vehicle component. The determination means compares the collected data with the reference data to analyze the state of the vehicle component.

### CITATION LIST

### Patent Literature

Patent Literature 1: Japanese Unexamined Patent Application Publication No. 11-125584
Patent Literature 2: Japanese Unexamined Patent Application Publication No. 2005-326380

### SUMMARY OF INVENTION

### Technical Problem

Detecting vehicle defects in advance by performing daily vehicle inspection is effective for maintaining vehicle safety. However, some inspection points are difficult to inspect in daily inspection, for example, the underfloor of a vehicle. In addition, in visual inspection and hammering test, vehicle defects are determined on the basis of the exterior of the vehicle and abnormal sound emitted from the vehicle. Such inspections require that the inspector performing the inspection work be skilled, and the effects of the inspection depends on the inspector. Therefore, the inspection level of the vehicle varies depending on the inspector, and the user may not be able to appropriately determine the defective part of the vehicle.

In the technique disclosed in Patent Literature 1, a failure cause and a failure part in a vehicle can be specified from a state during traveling, but it does not take into account the variation in inspection levels during parking. In addition, the technique disclosed in Patent Literature 2 collects data without being known to a driver of a vehicle, and analyzes the state of vehicle components on the basis of the collected data. Therefore, the technique disclosed in Patent Literature 2 does not take into account the use of the collected data by the user of the vehicle for inspection.

In view of the above-described problems, an object of the present disclosure is to provide a determination system, a server, a determination method, and a non-transitory computer readable medium that allow appropriate determination of a defective part of a vehicle.

### Solution to Problem

A determination system according to the present disclosure includes:

a server;

a travel data transmission apparatus configured to acquire travel data indicating a state of a vehicle during traveling and transmit the travel data to the server; and

a parking data transmission apparatus configured to acquire parking data indicating a state of the vehicle during parking and transmits the parking data to the server,

the server including:

reception means for receiving the travel data and the parking data; and

determination means for determining a defective part of the vehicle on the basis of the received travel data and the received parking data.

A server according to the present disclosure includes:

reception means for receiving travel data indicating a state of a vehicle during traveling from a travel data transmission apparatus and parking data indicating a state of the vehicle during parking from a parking data transmission apparatus; and

determination means for determining a defective part of the vehicle on the basis of the received travel data and the received parking data.

A determination method according to the present disclosure includes:

receiving travel data indicating a state of a vehicle during traveling from a travel data transmission apparatus and parking data indicating a state of the vehicle during parking from a parking data transmission apparatus; and determining a defective part of the vehicle on the basis of the received travel data and the received parking data.

A non-transitory computer readable medium storing a determination program according to the present disclosure causes a computer to execute:

a reception process of receiving travel data indicating a state of a vehicle during traveling from a travel data transmission apparatus and parking data indicating a state of the vehicle during parking from a parking data transmission apparatus; and

a determination process of determining a defective part of the vehicle on the basis of the received travel data and the received parking data.

### Advantageous Effects of Invention

The determination system, server, determination method, and non-transitory computer readable medium according to the present disclosure allows appropriate determination of a defective part of a vehicle.

### BRIEF DESCRIPTION OF DRAWINGS

FIG. 1 is a block diagram illustrating a configuration of a determination system according to a first example embodiment.

FIG. 2 is a diagram illustrating an overview of a determination system according to a second example embodiment.

FIG. 3 is a block diagram illustrating a configuration of a determination system according to the second example embodiment.

FIG. 4 is a block diagram illustrating a configuration of a server according to the second example embodiment.

FIG. 5 is a diagram illustrating an example of travel data and parking data according to the second example embodiment.

FIG. 6 is a diagram illustrating an example of inspection points and inspection details required of a user of a vehicle.

FIG. 7 is a diagram illustrating an example of a method by which the determination unit according to the second example embodiment detects detecting looseness of a bolt from an underfloor image of the vehicle.

FIG. 8 is a diagram illustrating an image of the method by which the determination unit according to the second example embodiment detects an abnormality occurring on the side of a vehicle body.

FIG. 9 is a diagram illustrating the flow of the determination unit according to the second example embodiment to determine a defective part of the vehicle.

FIG. 10 is a flowchart illustrating a process executed by a server according to the second example embodiment.

FIG. 11 is a block diagram illustrating a configuration of a server according to a third example embodiment.

FIG. 12 is a diagram illustrating an example of travel data according to the third example embodiment.

FIG. 13 is a diagram illustrating the flow of the determination unit according to the third example embodiment to determine a defective part of a vehicle.

FIG. 14 is a diagram illustrating a configuration example of hardware.

### EXAMPLE EMBODIMENT

### First Example Embodiment

Example embodiments of the present disclosure are described below with reference to the drawings.

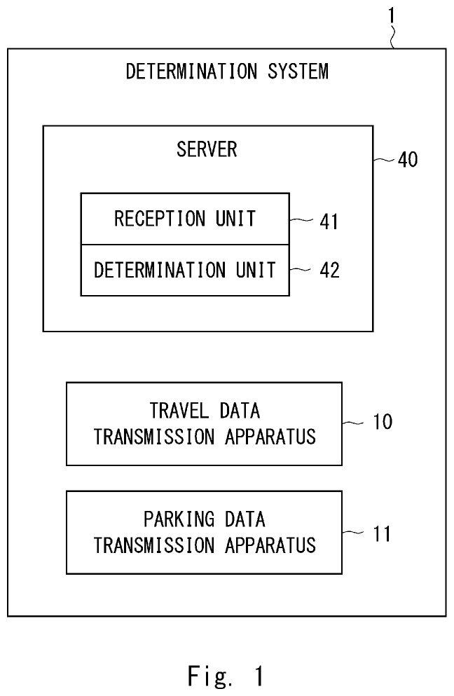

FIG. 1 is a block diagram illustrating a configuration of a determination system 1 according to the present example embodiment. As illustrated in the figure, the determination system 1 includes a server 40, a travel data transmission apparatus 10, and a parking data transmission apparatus 11. The travel data transmission apparatus 10 acquires travel data indicating the state of the vehicle during traveling, and transmits the travel data to the server 40. The parking data transmission apparatus 11 acquires parking data indicating the state of the vehicle during parking, and transmits the parking data to the server 40.

The server 40 includes a reception unit 41 that receives the travel data and parking data, and a determination unit 42 that determines a defective part of the vehicle on the basis of the received travel data and received parking data.

As described above, in the determination system 1 according to the present example embodiment, the travel data transmission apparatus 10 transmits travel data to the server 40, and the parking data transmission apparatus 11 transmits parking data to the server 40. The server 40 determines a defective part of the vehicle on the basis of the received travel data and parking data.

The determination system 1 according to the present example embodiment uses both the travel data and parking data to determine the defective part. If only the travel data were used, the server could detect any abnormality on the basis of the travel data. However, although the server can detect an abnormality, it may be difficult to specify the cause only by the travel data. In the present disclosure, the server 40 determines the defective part using the parking data in addition to the travel data. By using parking data, the determination system 1 can narrow down to some extent the cause of the abnormality that cannot be determined by the travel data. Therefore, the determination system 1 according to the present example embodiment can appropriately determine the defective part of the vehicle.

### Second Example Embodiment

Next, the determination system according to the present example embodiment will be described. The present example embodiment is a specific example of the first example embodiment described above.

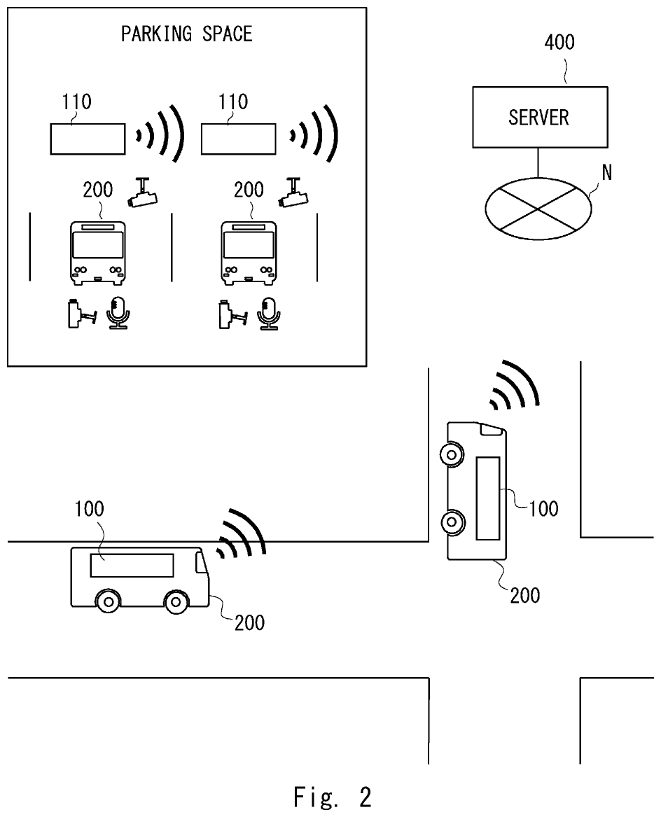

FIG. 2 is a diagram illustrating a configuration of a determination system according to the present example embodiment. In the determination system according to the present example embodiment, the vehicle 200 is equipped with a travel data transmission apparatus 100. The travel data transmission apparatus 100 acquires travel data indicating the state of the vehicle 200 during traveling, and transmits the travel data to the server 400. The vehicle 200 includes, for example, an automobile such as a bus, truck, or taxi. In the present example embodiment, when the vehicle 200 is traveling is when the vehicle 200 is in a state other than being parked in a parking space. The parking space may be a parking lot or garage, or a parking space at a business office where the vehicle 200 is stored. When the vehicle 200 is traveling includes the state in which the vehicle 200 is traveling as well as the state in which the vehicle 200 is temporarily stopped, such as at an intersection.

The travel data is data indicating the state of the vehicle 200 while traveling. The travel data may include, for example, information such as the speed, acceleration, and engine speed of the vehicle 200 during driving. The travel data also includes an exterior image of the vehicle 200. The travel data further includes sound information of a sound emitted from the vehicle 200.

In addition, a camera, a microphone, and a parking data transmission apparatus 110 are provided in the parking space of the vehicle 200. The camera captures an image of the exterior of the vehicle 200, and the microphone collects a sound emitted from the vehicle 200. The parking data transmission apparatus 110 acquires parking data indicating the state of the vehicle 200 during parking, and transmits the parking data to the server 400. In the present example embodiment, when the vehicle 200 is parked refers to when the vehicle 200 is parked in a parking space.

The parking data is data indicating the state of the vehicle 200 during parking. The parking data includes, for example, an exterior image of the vehicle 200 during parking captured by the camera. In addition, the parking data includes sound information of a sound emitted from the vehicle 200 during parking and collected by the microphone.

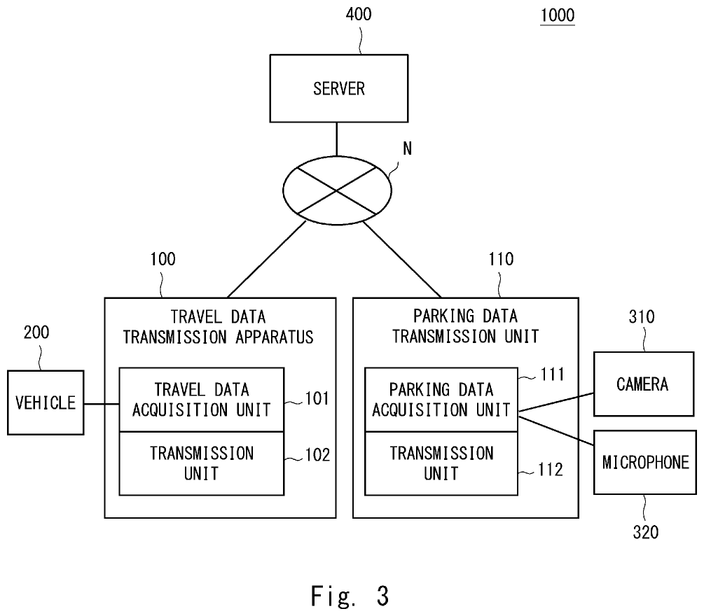

Next, the determination system 1000 according to the present example embodiment will be described with reference to FIG. 3. The figure is a block diagram illustrating a configuration of the determination system 1000. The determination system 1000 corresponds to the determination system 1 of the first example embodiment illustrated in FIG. 1.

The determination system 1000 includes a server 400, a travel data transmission apparatus 100, and a parking data transmission apparatus 110. The travel data transmission apparatus 100 and parking data transmission apparatus 110 are connected to the server 400 via a network N. The network N includes, for example, the Internet and a wireless communication network. The travel data transmission apparatus 100 and parking data transmission apparatus 110 acquires data indicating the state of the vehicle 200, and transmits the acquired data to the server 400.

The travel data transmission apparatus 100 corresponds to the travel data transmission apparatus 10 of the first example embodiment illustrated in FIG. 1. The travel data transmission apparatus 100 acquires travel data indicating the state of the vehicle 200 during traveling, and transmits the travel data to the server 400.

The travel data transmission apparatus 100 includes a travel data acquisition unit 101 and a transmission unit 102. The travel data acquisition unit 101 acquires, from the vehicle 200, travel data indicating the state of the vehicle 200 during traveling.

The travel data includes telematics information indicating the traveling state of the vehicle 200. The telematics information includes, for example, position information measured using a global positioning system (GPS). The travel data acquisition unit 101 acquires position information from, for example, a car navigation system.

The telematics information may include CAN information that can be acquired from a vehicle through a controller area network (CAN). The CAN information may include, for example, a vehicle speed, an engine speed, a shift position, and a steering angle. The telematics information may include diagnostic trouble code (DTC) information generated by various electric control units (ECUs) installed in the vehicle.

The traveling information includes various types of information indicating the state of the vehicle 200 during traveling other than the above. The traveling information may include, for example, information on the environment of the travel route of the vehicle 200. The information on the environment of the travel route of the vehicle 200 includes information such as weather, temperature, and humidity around the position of the vehicle 200. The information may be acquired from sensors provided in the vehicle 200, or by accepting any input from the user through an input interface (not illustrated).

The travel data is not limited to the telematics information described above. The travel data may further include an exterior image of the vehicle 200 during traveling of the vehicle 200. The exterior image may include, for example, an underfloor image of the vehicle 200 during traveling. The underfloor image is an image of the bottom surface of the vehicle 200. The bottom surface of the vehicle 200 is the surface at the bottom of the vehicle 200 that is opposite the road on which the vehicle 200 travels.

The travel data may further include sound information of a sound emitted by the vehicle 200 during traveling of the vehicle 200. Note that, in the present example embodiment, description will be given on the assumption that a camera and a microphone are not installed in the vehicle 200, and the travel data does not include an exterior image and sound information.

The transmission unit 102 transmits the acquired travel data to the server 400 via the network N.

The parking data transmission apparatus 110 corresponds to the parking data transmission apparatus 11 of the first example embodiment illustrated in FIG. 1. The parking data transmission apparatus 110 acquires parking data indicating the state of the vehicle 200 during parking, and transmits the parking data to the server 400.

The parking data transmission apparatus 110 includes a parking data acquisition unit 111 and a transmission unit 112.

The parking data acquisition unit 111 acquires parking data indicating the state of the vehicle 200 during parking. The parking data further includes an exterior image of the vehicle 200 during parking of the vehicle 200. The exterior image may include, for example, an underfloor image of the vehicle 200 during parking.

In the present example embodiment, the parking data acquisition unit 111 acquires the exterior images from the camera 310 provided in the parking space of the vehicle 200. The camera 310 is provided on a floor surface of the parking space, captures an underfloor image of the vehicle 200 from a predetermined direction, and outputs the captured image to the parking data acquisition unit 111. The camera 310 is fixed at a predetermined position in the parking space and functions as a fixed point camera. A plurality of cameras 310 may be provided, for example, at positions where the vehicle 200 can be shot from above, side, or behind. The camera 310 may be an infrared camera or the like capable of shooting even in a dark place.

The parking data further includes sound information of a sound emitted by the vehicle 200 during parking of the vehicle 200. In the present example embodiment, the parking data acquisition unit 111 acquires sound information from a microphone 320 provided in the parking space of the vehicle 200. For example, similarly to the camera 310, the microphone 320 is provided on the floor surface of the parking space, collects the sound emitted by the vehicle 200, and outputs the collected sound information to the parking data acquisition unit 111. A plurality of microphones 320 may be provided, and the microphone 320 may be provided not only on the parking space floor surface but also in other places.

The camera 310 and microphone 320 are preferably provided in the vicinity of an important component (for example, a muffler or a suspension) having a significant impact on vehicle safety. As a result, a change in the exterior of the important component and occurrence of an abnormal sound can be easily detected.

The transmission unit 112 transmits the acquired parking data to the server 400 via the network N.

Next, the configuration of the server 400 will be described. The server 400 corresponds to the server 40 of the first example embodiment illustrated in FIG. 1.

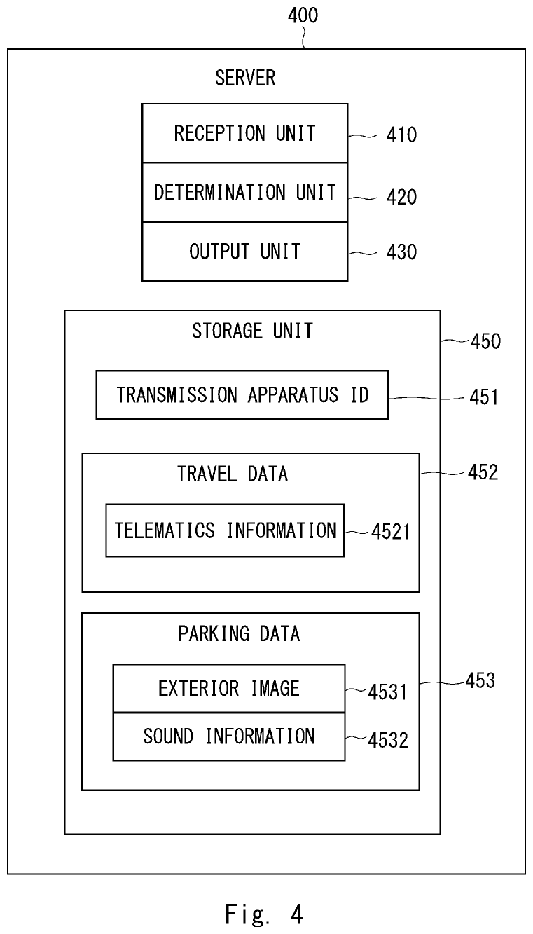

FIG. 4 is a block diagram illustrating a configuration of the server 400. The server 400 includes a reception unit 410, a determination unit 420, an output unit 430, and a storage unit 450.

The reception unit 410 corresponds to the reception unit 41 of the first example embodiment illustrated in FIG. 1. The reception unit 410 receives travel data and parking data. The reception unit 410 stores the received travel data and parking data in the storage unit 450 as the travel data 452 and parking data 453 in association with the transmission apparatus ID 451 for identifying the travel data transmission apparatus 100 or parking data transmission apparatus 110. The travel data 452 includes telematics information 4521 of the vehicle 200 during traveling. The parking data 453 further includes an exterior image 4531 and sound information 4532 of the vehicle 200 during parking. The exterior image 4531 also includes an underfloor image of the vehicle 200 during parking.

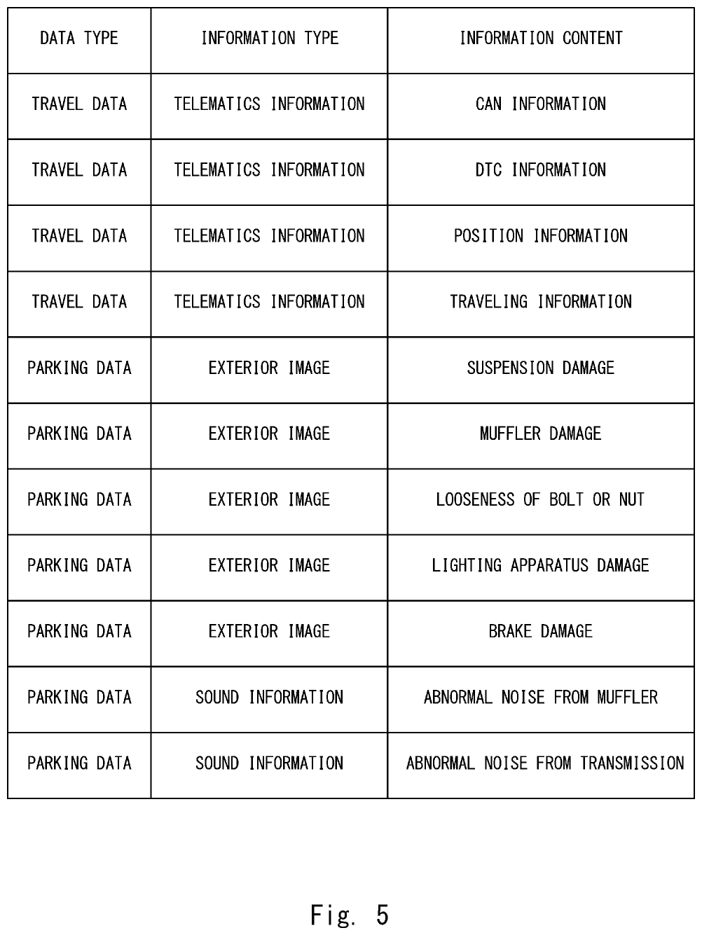

FIG. 5 is a diagram illustrating an example of travel data and parking data. As illustrated in the figure, the travel data includes, for example, CAN information, DTC information, position information, or traveling information. The parking data also includes an exterior image of, for example, suspension damage, muffler damage, looseness of a nut or bolt, damage to a lighting apparatus, or brake damage. The parking data includes an abnormal sound from a muffler or transmission as sound information.

Returning to FIG. 4, the description will be continued. The determination unit 420 corresponds to the determination unit 42 of the first example embodiment illustrated in FIG. 1. The determination unit 420 determines a defective part of the vehicle 200 on the basis of the received travel data and the received parking data.

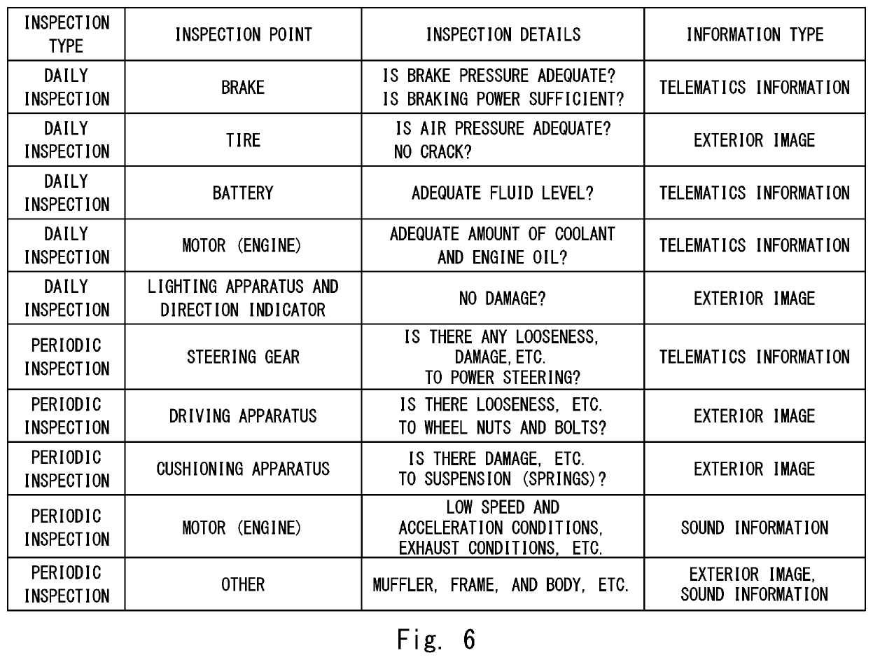

FIG. 6 is a diagram illustrating an example of inspection points and inspection details required of a user of a vehicle. As shown in the column of inspection type, inspection point, and inspection details in the figure, the user of a vehicle is required by laws and regulations to inspect each component of the vehicle in daily and periodic inspections.

As shown in the column of information type, the determination unit 420 can determine whether or not a defect has occurred at the inspection point using any one or a combination of telematics information, exterior image, and sound information.

First, when any of the acquired telematics information, exterior image, or sound information includes information indicating an abnormality, the determination unit 420 detects the abnormality. The following section describes an example of a method by which the determination unit 420 detects an abnormality using an exterior image including information indicating an abnormality.

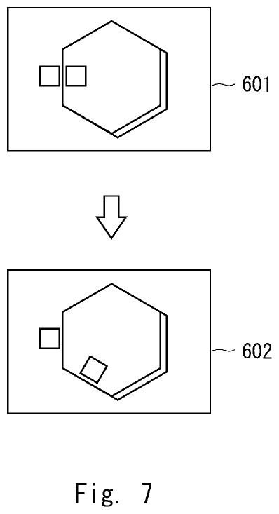

FIG. 7 is a diagram illustrating an example of a method of detecting looseness of a bolt from an underfloor image of the vehicle 200. It is assumed that the underfloor image captured by a camera includes bolt images 601 and 602 as illustrated in the figure.

First, as illustrated in the bolt image 601, a bolt and an object to be fixed with the bolt are marked in advance (square marks in the drawing). In a case where the bolt is loosened, as illustrated in the bolt image 602, the distance between the mark on the bolt and the mark on the object to be fixed becomes longer than that in the state of the bolt image 601. Using the bolt image 602, the determination unit 420 extracts the areas of the marks on the bolt and on the object to be fixed. When the distance between the mark on the bolt and the mark on the object to be fixed is equal to or more than a predetermined threshold, the determination unit 420 detects that the bolt has loosened.

As a result, the looseness of the bolt can be detected without the user visually observing the under the floor. Since many bolts are used under the floor of a vehicle, there are many inspection points, and there is a risk of inspection omission. In addition, when detecting an abnormality by classification, it is necessary to learn a large amount of data at the time of abnormalities, but it is difficult to acquire a large amount of data at the time of abnormalities. The method described above solves this problem, and can detect looseness of bolts efficiently.

Furthermore, for example, in order to detect an abnormality such as a crack in the vehicle body, a region classification technique in units of pixels may be used using the exterior image of the vehicle 200.

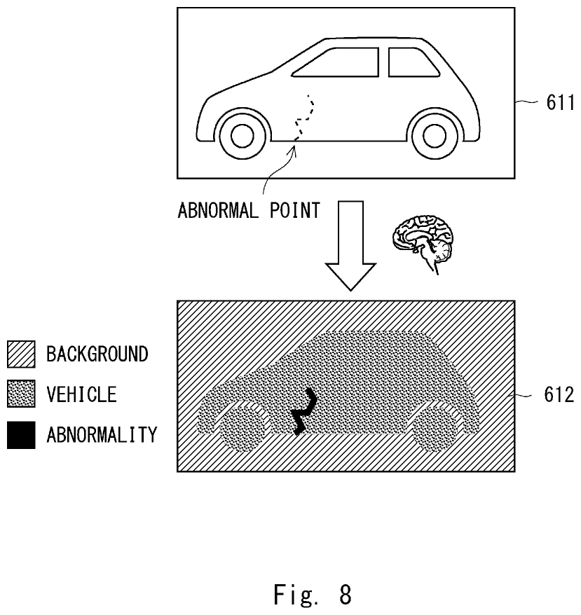

FIG. 8 is a diagram illustrating an image of the method for detecting abnormalities occurring on the sides of the vehicle body. The exterior image captured by the camera includes a side image 611 acquired by shooting the side of the vehicle body as illustrated in the figure.

The determination unit 420 detects an abnormal part by using a learned model that allows detection of an abnormal part on the basis of the exterior image of the side of the vehicle body. The determination unit 420 executes region classification of the side image 611, and acquires an extraction result image 612 illustrated in the figure as a result of region extraction. The determination unit 420 can classify the regions at a fine granularity in units of pixels by using the region classification technique. The determination unit 420 can efficiently detect a crack generated in the vehicle body.

The present invention is not limited to the above, and the determination unit 420 may detect an abnormality on the basis of telematics information or sound information.

Returning to FIG. 4, the description will be continued. The determination unit 420 determines a defective part of the vehicle 200 on the basis of the telematics information 4521 in the received travel data 452 and the exterior image 4531 and sound information 4532 in the parking data 453. When the determination unit 420 detects an abnormality from these pieces of information, it determines a defective part on the basis of the information including the abnormality. For example, the determination unit 420 detects an abnormality using the underfloor image of the vehicle 200 included in the exterior image 4531, and determines a defective part on the basis of the detected abnormality and the telematics information 4521 of the travel data 452.

The determination unit 420 determines the defective part using, for example, artificial intelligence (AI) for inspection that determines a defective part of the vehicle 200. The inspection AI executes determination using a machine-learned determination model that has been trained to determine the defective part of the vehicle on the basis of information indicating one or more abnormalities included in the telematics information, exterior image, and sound information. The inspection AI inputs information including an abnormality from the telematics information 4521, exterior image 4531, or sound information 4532 into the determination model to acquire a determination result of the defective part of the vehicle 200.

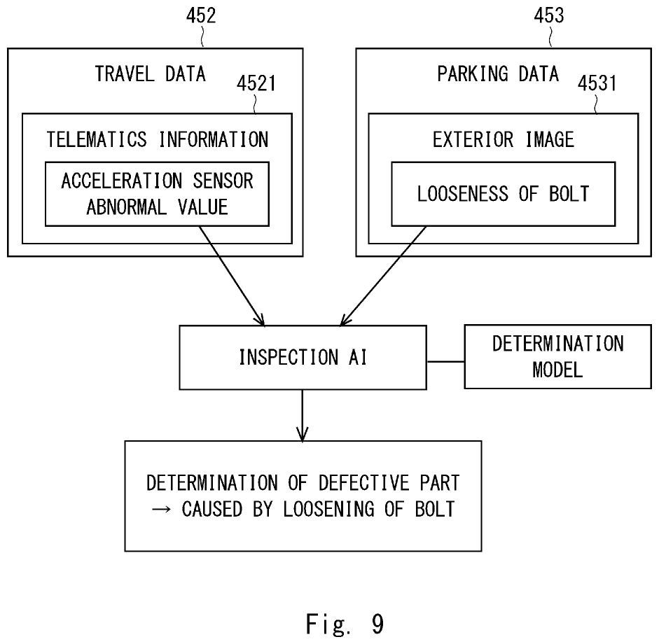

FIG. 9 is a diagram illustrating a flow of the determination unit 420 determining a defective part using the inspection AI. For example, it is assumed that the vehicle 200 is wobbling and shaking at a certain engine speed. The telematics information included in the travel data includes an abnormal value indicated by the acceleration sensor. In addition, it is assumed that looseness of a bolt in the damper portion of the suspension is detected in the underfloor image included in the parking data.

In such a case, the determination unit 420 extracts information indicating an abnormality from each of the telematics information of the travel data and the underfloor image included in the parking data, and inputs the extracted information to the determination model. The determination model determines a defective part on the basis of the abnormal value indicated by the acceleration sensor, wobble and shake of the vehicle, and looseness of the bolt, and outputs the determination result. As described above, by using the inspection AI, the determination unit 420 can comprehensively determine the defective part on the basis of a plurality of abnormalities.

If the determination unit 420 determines a defect using only the abnormal value of the acceleration sensor included in the telematics information in the travel data, the abnormality in the underfloor image included in the parking data is not taken into account in the determination. In such a case, since the determination unit 420 cannot determine the defective part in consideration of the looseness of the bolt in the damper portion of the suspension, the user may not correctly recognize the defective part.

The determination unit 420 determines the defective part on the basis of both travel data and parking data, and thus can properly determine the defective part of the abnormality that is occurring. In addition, since the determination unit 420 can determine the defective part in consideration of the exterior image and sound information of the vehicle 200, it can detect damage and a defect that cannot be detected by sensors and accurately specify the defective part.

The determination model may be weighted to identify the defective part according to the component or site including the abnormality. In such a case, the weighting value is defined in advance according to the component or site where the abnormality occurred. The determination model determines the defective part on the basis of the defined weighting value.

The present invention is not limited to the above, and the determination unit 420 may determine the defective part using other determination conditions. In addition, the determination unit 420 may input information including normal information as well as abnormal information to the inspection AI to acquire a determination result for the defective part. As a result, determination can be made in consideration of information on parts and components that are less likely to be defective parts.

The output unit 430 generates and outputs information to notify the user of the determination result. For example, the output unit 430 generates display information for displaying the determination result, and outputs the generated display information to a display apparatus (not illustrated). For example, when a defect occurs, the output unit 430 may notify the driver of the vehicle 200 that a defect has occurred and the defective part. In this way, the driver can quickly grasp the abnormality in the vehicle 200. The output unit 430 may change the timing of the output according to the defective part and degree of the impact on vehicle safety. For example, in a case where the defect has a significant impact on vehicle safety, the driver may be notified while the vehicle is traveling and urged to take immediate action. In a case where the defect has a small impact on safety, notification may be made at the time the vehicle 200 returns to a parking space such as a business office. Furthermore, in a case where it is determined that there is no defective part, the output unit 430 may output that fact.

Returning to FIG. 4, the description will be continued. The storage unit 450 stores the travel data received from the travel data transmission apparatus 100 and the parking data received from the parking data transmission apparatus 110 in association with the transmission apparatus ID 451.

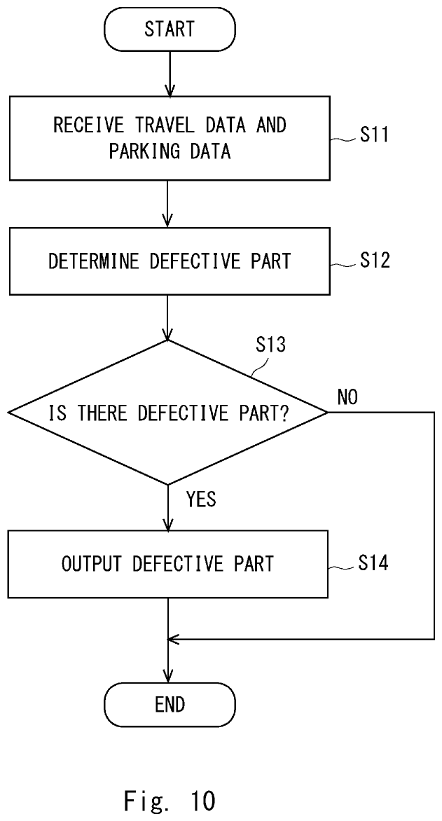

Next, processing executed by the server 400 will be described with reference to a flowchart illustrated in FIG. 10

First, the reception unit 410 (see FIG. 4) receives the travel data and parking data from the travel data transmission apparatus 100 and parking data transmission apparatus 110 (see FIG. 3), respectively (S11). The travel data includes telematics information. The parking data also includes exterior images and sound information.

The determination unit 420 (see FIG. 4) detects an abnormality included in the data on the basis of the received travel data and parking data. In addition, the determination unit 420 determines a defective part of the vehicle 200 using the inspection AI on the basis of the detected abnormality (S12).

The output unit 430 determines whether or not there is a defective part (S13). If there is a defective part (YES in S13), the output unit 430 generates and outputs information to inform the user of the determination result (S14). If no defective parts are found (NO in S13), the process is ended.

As described above, in the determination system 1000 according to the present example embodiment, the server 400 receives the travel data and parking data of the vehicle 200, and determines the defective part of the vehicle 200 on the basis of the received travel data and parking data. In addition, the server 400 notifies the user of the determination result. The user can easily grasp the defective part, and thus can efficiently inspect the vehicle 200.

The parking data also includes an exterior image including an underfloor image of the vehicle 200. The parking data also includes sound information on a sound emitted by the vehicle 200. Since the server 400 detects damage to a component and the occurrence of abnormal sound using image recognition or voice recognition, it can detect an abnormality that would be difficult to detect using only telematics information during traveling. Then, since the server 400 determines the defective part on the basis of the detected abnormality, the defective part can be determined accurately. The user can then grasp the determination result, which makes inspection work more efficient and stabilizes inspection quality.

### Third Example Embodiment

The present example embodiment is a specific example of the first example embodiment described above. In the second example embodiment, the parking data transmission apparatus 110 (see FIG. 3) acquires the exterior image and sound information from the camera 310 and microphone 320 provided in the parking space, and transmits these pieces of information to the server 400. In the present example embodiment, a camera and a microphone are provided on the bottom surface of the vehicle 200, and the camera and microphone provided on the bottom surface of the vehicle 200 acquire an exterior image and an underfloor image during traveling, respectively. Therefore, the travel data transmission apparatus 100 installed in the vehicle 200 transmits the travel data including the exterior image and sound information to the server 400 in addition to the telematics information.

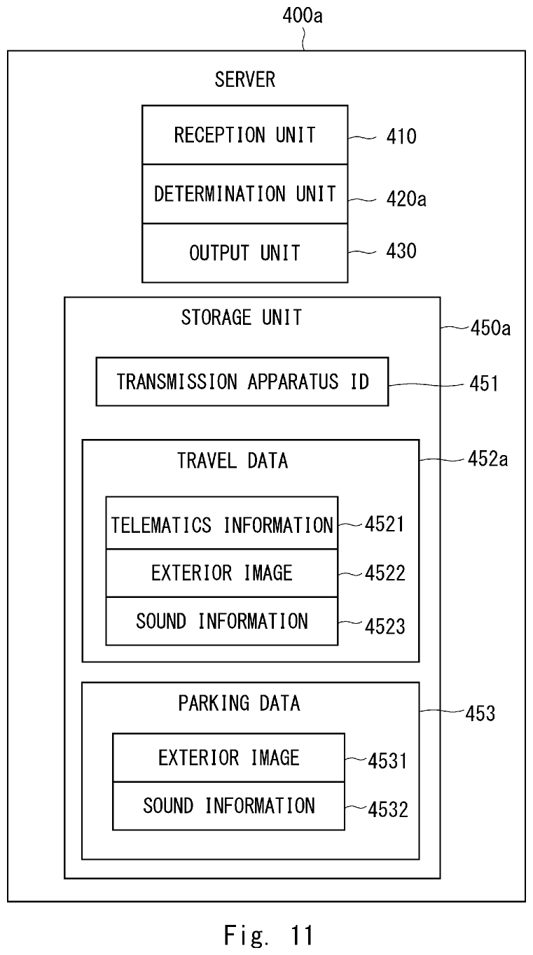

FIG. 11 is a block diagram illustrating a configuration of a server 400a according to the present example embodiment. The server 400a includes a reception unit 410, a determination unit 420a, an output unit 430, and a storage unit 450a. Since the configurations of the reception unit 410 and output unit 430 are similar to those of the reception unit 410 and output unit 430 of the second example embodiment illustrated in FIG. 3, detailed description thereof will be omitted. The determination unit 420a corresponds to the determination unit 420 of the second example embodiment illustrated in FIG. 4. The storage unit 450a corresponds to the storage unit 450 of the second example embodiment illustrated in FIG. 4.

In the present example embodiment, unlike the second example embodiment, a camera and a microphone are installed on the bottom surface of the vehicle 200. The camera and microphone acquire an underfloor images and sound information during traveling, respectively.

The configuration of the travel data transmission apparatus 100 is similar to that of the travel data transmission apparatus 100 of the second example embodiment illustrated in FIG. 3. The travel data acquisition unit 101 acquires, from the vehicle 200, travel data indicating the state of the vehicle 200 during traveling. The travel data includes telematics information indicating the traveling state of the vehicle 200. In the present example embodiment, the travel data further includes an exterior image external appearance image captured by a camera provided on the bottom surface of the vehicle 200. The exterior image also includes an underfloor image of the vehicle 200. In addition, the travel data further includes sound information of a sound emitted from the vehicle 200 collected by a microphone provided on the bottom surface of the vehicle 200.

Therefore, as illustrated in FIG. 11, the travel data 452a in the storage unit 450a includes not only the telematics information 4521 but also the exterior image 4522 and sound information 4523.

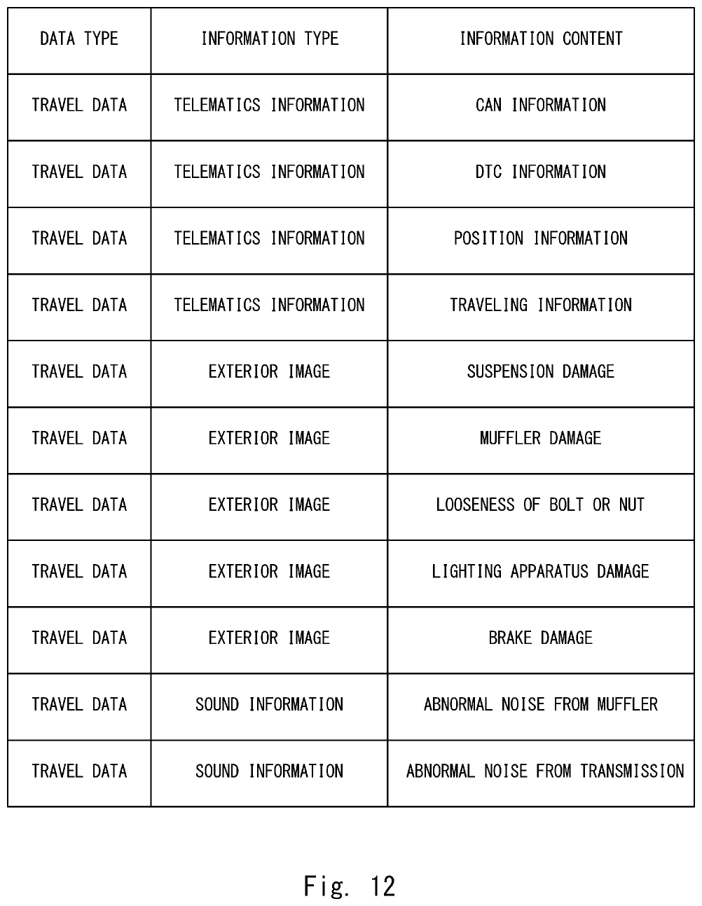

FIG. 12 is a diagram illustrating an example of travel data according to the present example embodiment. In the second example embodiment, the exterior image and sound information of the suspension, muffler, and the like are transmitted to the server by the parking data transmission apparatus. In the present example embodiment, the travel data transmission apparatus can transmit these pieces of information to the server. Therefore, as illustrated in the figure, the travel data also includes an exterior image including suspension damage and sound information including an abnormal sound from a muffler.

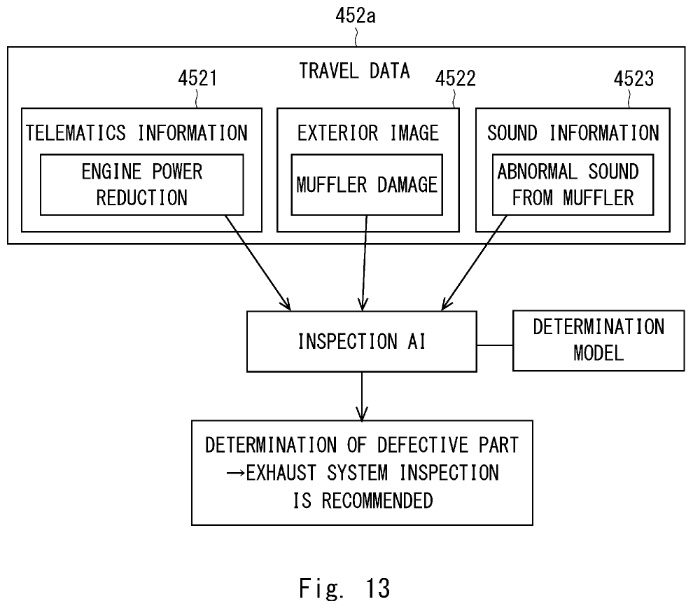

FIG. 13 is a diagram illustrating a flow of the determination unit 420a determining the defective part using the received travel data. The flow of the determination is similar to that in the second example embodiment illustrated in FIG. 9.

For example, it is assumed that the telematics information includes information indicating an abnormality of decreased engine power. In addition, it is assumed that the exterior image includes an image indicating damage to the muffler, and the sound information includes an abnormal sound emitted from the muffler.

The determination unit 420 a detects an abnormality from each of the telematics information, exterior image, and sound information, and comprehensively determines a defective part using the inspection AI on the basis of the detection details. Since the determination unit 420a determines the defective part in consideration of not only the telematics information but also the exterior image and sound information, it can, for example, notify the user that the defective part is not in the engine itself but in the exhaust system, and recommend inspection.

Note that, in addition to the camera and microphone installed in the vehicle 200, a camera and a microphone may be installed in the parking space as in the second example embodiment. In this way, the determination unit 420a can determine the defective part including the exterior image and sound information of the parking data in addition to the telematics information, exterior image, and sound information of the travel data.

As described above, according to the determination system according to the present example embodiment, since the travel data transmission apparatus 100 transmits the telematics information, exterior image, and sound information acquired by the travel data acquisition unit 101 to the server 400, and thus can achieve effects similar to those of the second example embodiment. In addition, the travel data transmission apparatus 100 can transmit the underfloor image and sound information during traveling in association with the telematics information. Therefore, for example, the server 400 determines the defective part more accurately because it can determine the defective part in consideration of the rotation speed of the engine when the abnormal sound occurs.

### <Configuration Example of Hardware>

The functional components of the server 400 and others may be realized by hardware (for example, a hard-wired electronic circuit or the like) that realizes the functional components, or by a combination of hardware and software (for example, a combination of an electronic circuit and a program that controls the electronic circuit or the like). Hereinafter, a case where each functional component of the server 400 and others is realized by a combination of hardware and software will be further described.

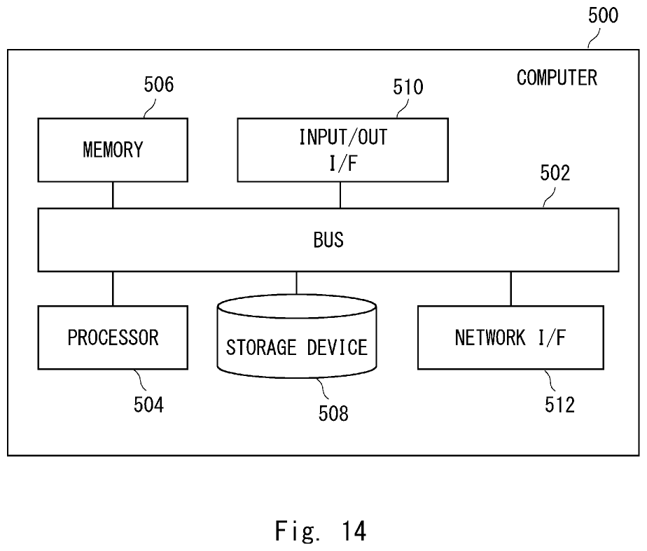

FIG. 14 is a block diagram illustrating a hardware configuration of a computer 500 that realizes the server 400 and others. The computer 500 may be a portable computer such as a smartphone or a tablet terminal. The computer 500 may be a dedicated computer designed to realize the server 400 and others, or may be a general-purpose computer.

For example, by installing predetermined applications in the computer 500, the functions of the server 400 and others are realized in the computer 500. The applications are composed of programs for realizing the functional components of the server 400 and others.

The computer 500 includes a bus 502, a processor 504, a memory 506, a storage device 508, an input/output interface 510, and a network interface 512. The bus 502 is a data transmission path for the processor 504, the memory 506, the storage device 508, the input/output interface 510, and the network interface 512 to transmit and receive data to and from each other. However, the method of connecting the processor 504 and others to each other is not limited to the bus connection.

The processor 504 is a variety of processors such as a central processing unit (CPU), a graphics processing unit (GPU), or a field-programmable gate array (FPGA). The memory 506 is a main storage device realized by using a random access memory (RAM) or the like. The storage device 508 is an auxiliary storage device realized by using a hard disk, a solid state drive (SSD), a memory card, read only memory (ROM), or the like.

The input/output interface 510 is an interface for connecting the computer 500 and an input/output apparatus. For example, an input apparatus such as a keyboard and an output apparatus such as a display apparatus are connected to the input/output interface 510.

The network interface 512 is an interface for connecting the computer 500 to a network. The network may be a local area network (LAN) or a wide area network (WAN).

The storage device 508 stores programs (programs for realizing the above-described applications) for realizing the functional components of the server 400 and others. The processor 504 reads this program into the memory 506 and executes it to realize the functional components of the server 400 and others.

Note that the present disclosure is not limited to the above example embodiments, and can be appropriately changed without departing from the gist.

For example, in the above description, the server receives data from the travel data transmission apparatus and parking data transmission apparatus, detects an abnormality in the received data, and determines the defective part, but the present invention is not limited to this description. The travel data transmission apparatus or parking data transmission apparatus may detect an abnormality in data acquired by each apparatus and transmit data including the abnormality to the server when detecting the abnormality. As a result, the amount of communication required for communication between the travel data transmission apparatus or parking data transmission apparatus and the server can be reduced.

Furthermore, the camera and microphone may be provided in a place that is neither a vehicle nor a parking space. The camera and microphone may be provided in an infrastructure including a facility provided near a road, for example, a traffic light. For example, the camera captures an underfloor image of a vehicle that is stopped at an intersection to wait for a traffic light, and the microphone collects a sound emitted from the vehicle. Further, the underfloor image and sound information may be acquired not only while the vehicle is stopped but also while it is traveling. Furthermore, an image of an area other than the underfloor space, such as the front or side portion of the vehicle, may be captured.

As a result, an abnormality can be detected and a defective part can be determined even in a vehicle that does not include a camera, a microphone, and a transmission apparatus.

Furthermore, the present disclosure may be applied not only to business vehicles such as buses, trucks, or taxis as described above, but also to private vehicles. The present invention may be also applied to emergency or special vehicles used by police, fire departments, medical institutions, or the like. The present invention may be also applied to railway vehicles, aircrafts, ships, and the like.

In the above-described examples, the programs can be stored and supplied to the computer using various types of non-transitory computer readable media. Non-transitory computer readable media include various types of tangible storage media. Examples of non-transitory computer readable media include magnetic storage media (for example, floppy disks, magnetic tapes, and hard disk drives), optical magnetic storage media (for example, magneto-optical disks, optical disk media such as compact disc (CD) and digital versatile disks (DVD), and semiconductor memories (for example, mask ROM, programmable ROM (PROM), erasable PROM (EPROM), flash ROM, and RAM). The program may also be supplied to computers using various types of transitory computer readable media. Examples of the transitory computer readable media include electric signals, optical signals, and electromagnetic waves. The transitory computer readable media can supply programs to computers via wired or wireless communication paths, such as wires and optical fiber.

### REFERENCE SIGNS LIST

1 DETERMINATION SYSTEM
10 TRAVEL DATA TRANSMISSION APPARATUS
11 PARKING DATA TRANSMISSION APPARATUS
40 SERVER
41 RECEPTION UNIT
42 DETERMINATION UNIT
100 TRAVEL DATA TRANSMISSION APPARATUS
101 TRAVEL DATA ACQUISITION UNIT
102 TRANSMISSION UNIT
110 PARKING DATA TRANSMISSION APPARATUS
111 PARKING DATA ACQUISITION UNIT
112 TRANSMISSION UNIT
200 VEHICLE
310 CAMERA
320 MICROPHONE
400, 400a SERVER
410 RECEPTION UNIT
420, 420a DETERMINATION UNIT
430 OUTPUT UNIT
450, 450a STORAGE UNIT
451 TRANSMISSION APPARATUS ID
452, 452a TRAVEL DATA
453 PARKING DATA
500 COMPUTER
502 BUS
504 PROCESSOR
506 MEMORY
508 STORAGE DEVICE
510 INPUT/OUTPUT INTERFACE
512 NETWORK INTERFACE
601, 602 BOLT IMAGE
611 SIDE IMAGE
612 EXTRACTION RESULT IMAGE
1000 DETERMINATION SYSTEM
4521 TELEMATICS INFORMATION
4522, 4531 EXTERIOR IMAGE
4523, 4532 SOUND INFORMATION
N NETWORK

What is claimed is:

1. A determination system comprising:
a server;
a travel data transmission apparatus configured to acquire travel data indicating a state of a vehicle during traveling and transmit the travel data to the server; and
a parking data transmission apparatus configured to acquire parking data indicating a state of the vehicle during parking and transmits the parking data to the server,
the server including:
at least one memory storing instructions, and
at least one processor configured to execute the instructions to:
receive the travel data and the parking data; and
determine a defective part of the vehicle on a basis of the received travel data and the received parking data.

2. The determination system according to claim 1, wherein the travel data includes at least one of telematics information indicating a traveling state of the vehicle, an exterior image of the vehicle during traveling, and sound information of a sound emitted by the vehicle during traveling.

3. The determination system according to claim 1, wherein the parking data includes at least one of an exterior image of the vehicle during parking and sound information of a sound emitted by the vehicle during parking.

4. The determination system according to claim 1, wherein
at least one of the travel data or parking data further includes an underfloor image of the vehicle, and
the at least one processor is further configured to execute the instructions to detect an abnormality in the vehicle using the underfloor image, and determine the defective part on a basis of the abnormality and the travel data.

5. The determination system according to claim 1, wherein the at least one processor is further configured to execute the instructions to determine the defective part using a learned model that has learned to determine a defect in the vehicle on a basis of at least one of the travel data and the parking data.

6. A server comprising:
at least one memory storing instructions, and
at least one processor configured to execute the instructions to:
receive travel data indicating a state of a vehicle during traveling from a travel data transmission apparatus and parking data indicating a state of the vehicle during parking from a parking data transmission apparatus; and
determine a defective part of the vehicle on a basis of the received travel data and the received parking data.

7. The server according to claim 6, wherein the travel data includes at least one of telematics information indicating a traveling state of the vehicle, an exterior image of the vehicle during traveling, and sound information of a sound emitted by the vehicle during traveling.

8. A determination method comprising:
receiving travel data indicating a state of a vehicle during traveling from a travel data transmission apparatus and parking data indicating a state of the vehicle during parking from a parking data transmission apparatus; and
determining a defective part of the vehicle on a basis of the received travel data and the received parking data.

9. (canceled)

10. The server according to claim 6, wherein the parking data includes at least one of an exterior image of the vehicle during parking and sound information of a sound emitted by the vehicle during parking.

11. The server according to claim 6, wherein
at least one of the travel data or parking data further includes an underfloor image of the vehicle, and
the at least one processor is further configured to execute the instructions to detect an abnormality in the vehicle using the underfloor image, and determine the defective part on a basis of the abnormality and the travel data.

12. The server according to claim 6, wherein the at least one processor is further configured to execute the instructions to determine the defective part using a learned model that has learned to determine a defect in the vehicle on a basis of at least one of the travel data and the parking data.

13. The determination method according to claim 8, wherein the travel data includes at least one of telematics information indicating a traveling state of the vehicle, an exterior image of the vehicle during traveling, and sound information of a sound emitted by the vehicle during traveling.

14. The determination method according to claim 8, wherein the parking data includes at least one of an exterior image of the vehicle during parking and sound information of a sound emitted by the vehicle during parking.

15. The determination method according to claim 8, wherein
at least one of the travel data or parking data further includes an underfloor image of the vehicle, and
determining the defective part of the vehicle comprises detecting an abnormality in the vehicle using the underfloor image, and determining the defective part on a basis of the abnormality and the travel data.

16. The determination method according to claim 8, wherein determining the defective part of the vehicle comprises determining the defective part using a learned model that has learned to determine a defect in the vehicle on a basis of at least one of the travel data and the parking data.
